(19) United States
(12) Patent Application Publication
(10) Pub. No.: US 2018/0317664 A1
(43) Pub. Date: Nov. 8, 2018

(54) HEIGHT-ADJUSTABLE BED

(71) Applicant: SAMHONGSA CO., LTD., Seoul (KR)

(72) Inventors: Woo-Kee MIN, Seoul (KR); Yong-A PARK, Seoul (KR); Min-Jae KIM, Seoul (KR)

(21) Appl. No.: 15/772,452

(22) PCT Filed: Oct. 28, 2016
(86) PCT No.: PCT/KR2016/012299

§ 371 Date: Jul. 2, 2018

(30) Foreign Application Priority Data
Oct. 28, 2015 (KR) 10-2015-0150174

(51) Int. Cl. A47C 20/04; A47C 17/16; A47C 19/04; A61G 7/012; A61G 7/015; A61G 7/018

(52) U.S. Cl. CPC A47C 20/048; A47C 17/163; A61G 7/018; A61G 7/012; A61G 7/015; A47C 19/045

(57) ABSTRACT

Disclosed is a height-adjustable bed including: a base; a support frame placed on an upper surface of the base; a mattress stably placed on an upper surface of the support frame; and a height adjusting device connected to the support frame and the base to adjust the height and tilt of the support frame, wherein the height adjusting device includes a gas spring or a spring lever to manually adjust the height of the support frame.

### TECHNICAL FIELD

The present disclosure relates to a height-adjustable bed.

### BACKGROUND ART

In general, homes are equipped with beds to help people comfortably sleep. In the related art, beds have fixed standard heights without a function for adjusting the angle or height of their mattresses.

Therefore, people frequently using beds at home to read books or watch movies in a posture of leaning their back on the headboard of a bed or lying on the bed may have health problems such as a herniated cervical disc or accumulated physically stress. In addition, although users having backache have to lift their lower bodies to some degree for deep sleep, normal beds do not have a function for users to lift their lower bodies, and thus users having backache may not have a good sleep.

In general, hospital beds have a height-adjustment function for transfer of patients or the convenience of patients. However, such hospital beds are configured to be adjusted in mattress height using motors electrically connected thereto. Such electrically connected motor-equipped beds have the following problems.

First, since the mattress of a bed is vertically movable by a motor connected thereto, the supply of electricity is necessary.

That is, an additional external power supply is necessary to supply power, and electricity may be wasted while current flows for supplying electricity.

Secondly, since a motor and a circuit for connection with a power supply source are necessary for constituting a bed, bed manufacturing processes may be complex, and manufacturing costs may high. In addition, selling prices of beds may increase.

The above-described background art is technical information that the inventors had or learned when or while inventing the present invention and may not be publicly known before the filing of the present patent application.

### DESCRIPTION OF EMBODIMENTS

### Technical Problem

The present disclosure is provided to improve the above-described problems.

### Solution to Problem

According to an embodiment of the present disclosure, a height-adjustable bed includes: a base; a support frame placed on an upper surface of the base; a mattress stably placed on an upper surface of the support frame; and a height adjusting device connected to the support frame and the base to adjust the height and tilt of the support frame, wherein the height adjusting device includes a gas spring or a spring lever to manually adjust the height of the support frame.

### Advantageous Effects of Disclosure

The height-adjustable bed of the embodiment of the present disclosure has the following effects.

First, the mattress of the height-adjustable bed may be moved upward and downward using the gas spring or spring lever without electricity.

Secondly, since electricity is not used, electricity is not wasted, and since only the gas spring and the spring lever are used, manufacturing costs may decrease and manufacturing processes may be simple.

Thirdly, since the manufacturing costs and manufacturing processes of the height-adjustable bed are low and simple, the height-adjustable bed may be mass produced with low costs.

### BRIEF DESCRIPTION OF DRAWINGS

FIG. 1 is a perspective view illustrating a bed according to an embodiment of the present disclosure.

FIG. 2 is a perspective view illustrating the bed of FIG. 1 without a mattress, the bed being adjustable in height.

FIG. 3 is a perspective view illustrating a height adjusting operation of the bed of FIG. 2.

FIG. 4 is a perspective view illustrating a height adjusting operation of the bed of FIG. 1.

FIG. 5 is a bottom perspective view illustrating a bottom side of the bed of FIG. 1.

FIG. 6 is an enlarged view illustrating a portion A of FIG. 5.

FIG. 7 is a bottom view illustrating the bottom side of the bed of FIG. 1.

FIG. 8 is an enlarged view illustrating the portion A when a spring lever is manipulated for height adjustment.

FIGS. 9A and 9B are enlarged views illustrating the portion A from a rear end side of the bed during height adjustment.

FIG. 10 is a side view illustrating a gas spring of the bed of the embodiment of the present disclosure.

FIG. 11 is a side view illustrating the bed of the embodiment of the present disclosure when being used without a support frame.

FIG. 12 is a rear view illustrating the bed of FIG. 11.

FIG. 13 is a perspective view illustrating the bed of FIG. 11.

FIG. 14 is a side view illustrating a bed according to a second embodiment of the present disclosure.

FIG. 15 is a perspective view illustrating a bed according to a third embodiment of the present disclosure.

FIG. 16 is a perspective view illustrating a height adjusting operation of the bed of the third embodiment of the present disclosure.

FIG. 17 is a perspective view illustrating the bed of FIG. 13 with a mattress of the bed being transparently illustrated.

FIG. 18 is a side view illustrating the bed FIG. 13.

FIG. 19 is an enlarged view illustrating a configuration of a lower support frame of the bed of FIG. 13.

FIG. 20 is a perspective view illustrating a bed according to a fourth embodiment of the present disclosure.

FIG. 21 is a side view illustrating the bed of the fourth embodiment of the present disclosure.

FIG. 22 is a side view illustrating the bed of the fourth embodiment of the present disclosure when being used without a support frame.

FIG. 23 is a perspective view illustrating a height-adjustable bed according to a fifth embodiment of the present disclosure.

FIG. 24 is a perspective view illustrating a height adjusting operation of the height-adjustable bed of the fifth embodiment of the present disclosure.

FIG. 25 is a bottom perspective view illustrating the height-adjustable bed of the fifth embodiment of the present disclosure.

### MODE OF DISCLOSURE

Hereinafter, embodiments of the present disclosure will be described in detail with reference to the accompanying drawings. In the drawings, like reference numerals denote like elements, and overlapping descriptions thereof will be omitted. In the following description, terms ending with “module” and “unit” are used or interchangeably used only for ease of description, and it is not intended to distinguish meanings or functions with the terms. Moreover, in the following descriptions of embodiments, detailed descriptions related to well-known techniques may not be presented in order not to unnecessarily obscure subject matters of the embodiments of the present disclosure. In addition, the accompanying drawings are only for helping easy understanding of the embodiments of the present disclosure and are not for limiting the technical idea of the present disclosure, and it should be understood that modifications, equivalents, and replacements could be made without departing from the technical idea and scope of the present disclosure.

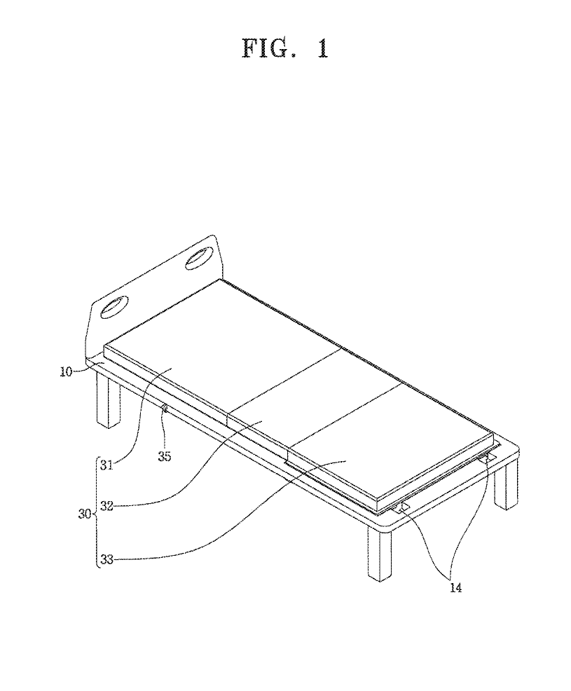

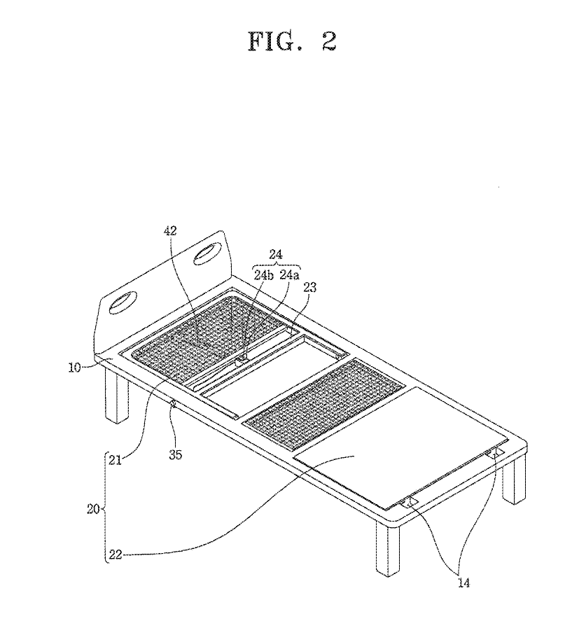

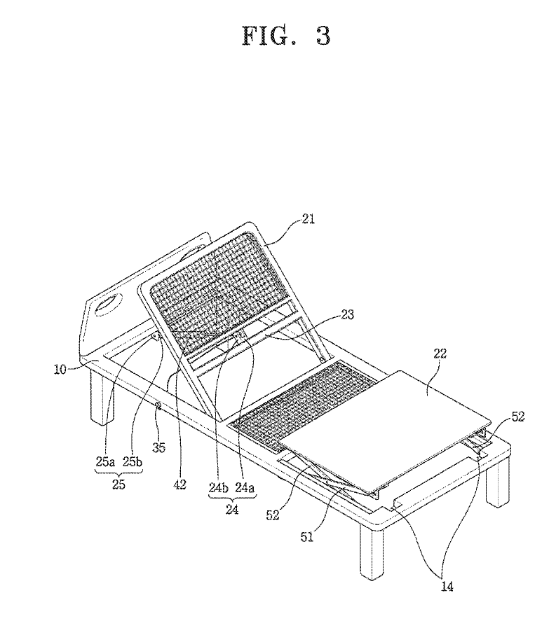

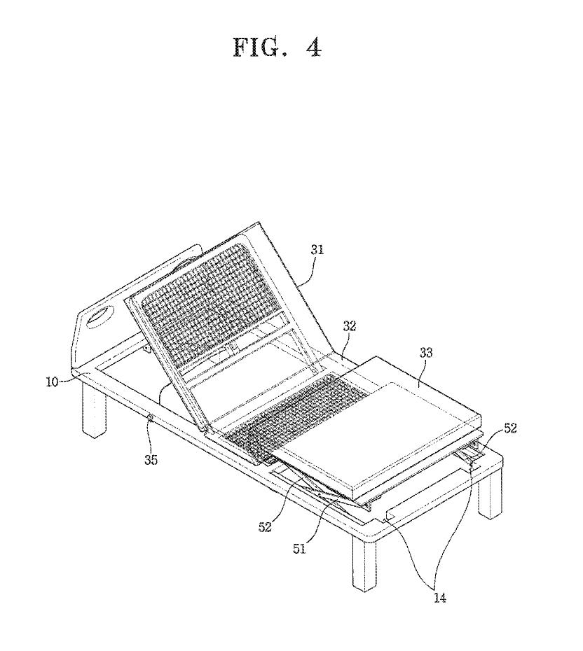

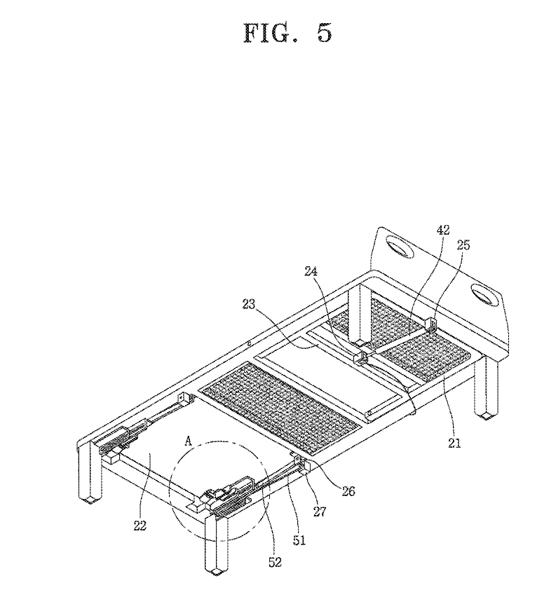

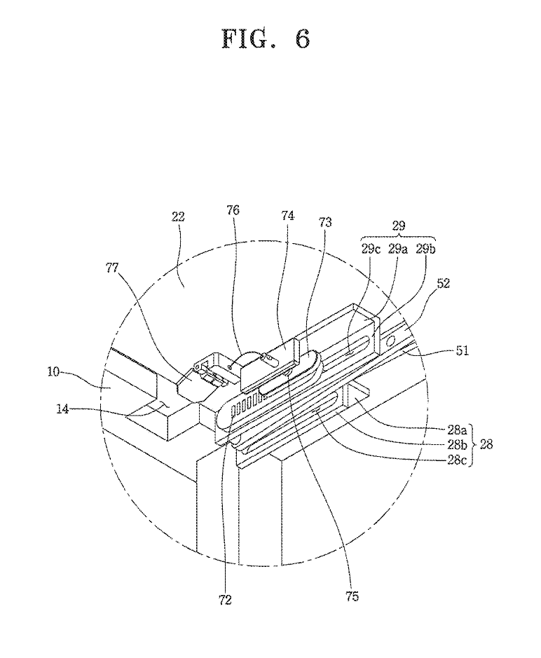

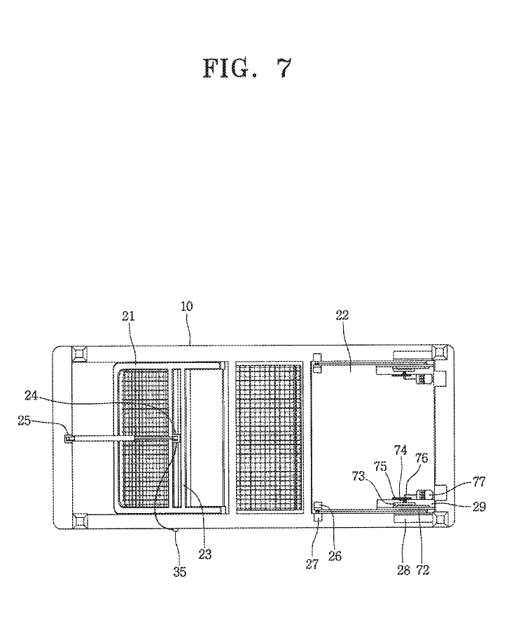

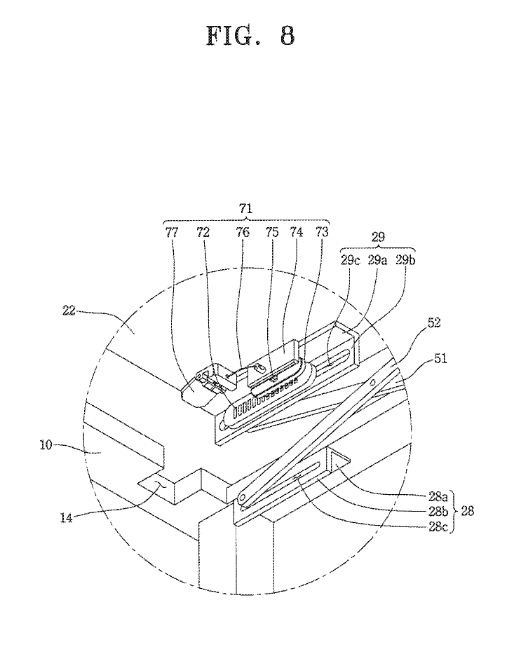

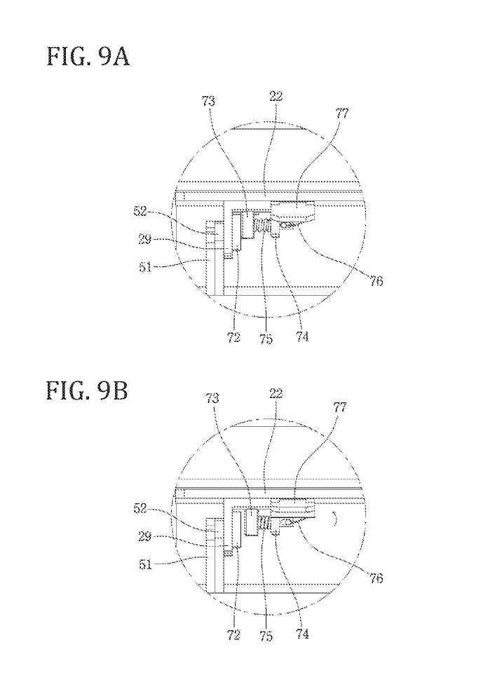

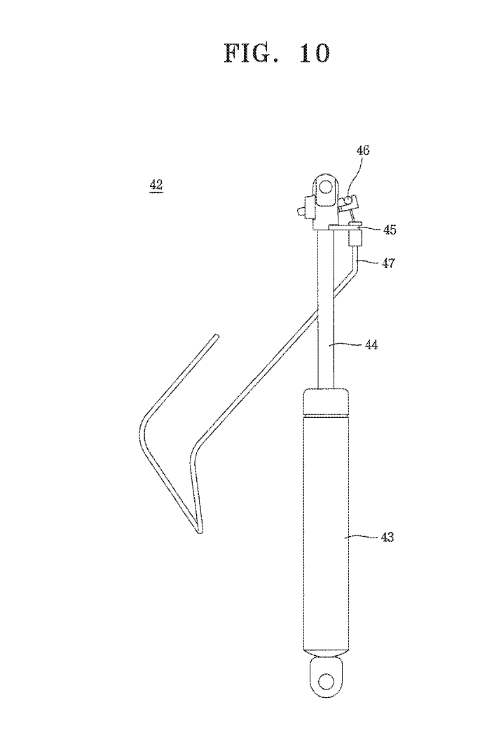

FIG. 1 is a perspective view illustrating a bed according to an embodiment of the present disclosure, and FIG. 2 is a perspective view illustrating the bed of FIG. 1 without a mattress, the bed being adjustable in height. FIG. 3 is a perspective view illustrating a height adjusting operation of the bed of FIG. 2, FIG. 4 is a perspective view illustrating a height adjusting operation of the bed of FIG. 1, and FIG. 5 is a bottom perspective view illustrating a bottom side of the bed of FIG. 1. FIG. 6 is an enlarged view illustrating a portion A of FIG. 5, FIG. 7 is a bottom view illustrating the bottom side of the bed of FIG. 1, and FIG. 8 is an enlarged view illustrating the portion A in a height adjustment operation. FIGS. 9A and 9B are enlarged views illustrating the portion A from a rear end side of the bed during height adjustment, and FIG. 10 is a side view illustrating a gas spring of the bed of the embodiment of the present disclosure.

Referring to FIGS. 1 to 10, the bed of the embodiment of the present disclosure may include a base 10, a mattress 30 placed on an upper portion of the base 10, a support frame 20 placed between the mattress 30 and the base 10 to support the mattress 30, and a height adjusting device connecting the support frame 20 and the base 10 to each other and configured to adjust the height and tilt of the support frame 20 for adjusting the height and tilt of the mattress 30.

The base 10 forms a lower portion of the bed, and a lower surface of the base 10 may be in contact with the ground or floor or may be spaced apart from the ground or floor by a given distance by a plurality of support legs formed on the lower surface of the base 10. A headboard may be bent from an upper portion of the base 10 in a direction perpendicular to the ground such that a user may lean on the headboard.

The mattress 30 is formed of a mattress material used for general beds and provides a section on which a user may lie. In detail, the mattress 30 may include an upper mattress 31 placed at an upper position of an upper surface of the base 10, a lower mattress 33 placed at a lower position of the upper surface of the base 10, and an intermediate mattress 32 placed between the upper mattress 31 and the lower mattress 33. The upper mattress 31, the intermediate mattress 32, and the lower mattress 33 may be separate from each other. When the height of the bed is not adjusted, the upper mattress 31, the intermediate mattress 32, and the lower mattress 33 may be arranged in parallel to each other like a single mattress. In addition, the base 10 may include an upper base supporting a lower surface of the upper mattress 31, an intermediate base supporting the intermediate mattress 32, and a lower base supporting the lower mattress 33. The upper mattress 31, the intermediate mattress 32, and the lower mattress 33 will be described later in more detail.

The support frame 20 is placed between the mattress 30 and the base 10 to support a lower surface of the mattress 30 and may be adjusted in height when the height adjusting device (41 and 71) is manipulated. In detail, the support frame 20 may include: an upper support frame 21 supporting the lower surface of the upper mattress 31 and adjustable in tilt angle by the height adjusting device, an intermediate support frame supporting a lower surface of the intermediate mattress 32, and a lower support frame 22 supporting a lower surface of the lower mattress 33 and adjustable in height by the height adjusting device. In addition, for ease of description, in the base 10, the upper base is named as so because the upper support frame 21 is stable placed on the upper base, the intermediate base is named as so because the intermediate support frame is stably placed on the intermediate base, and the lower base is named as so because the lower support frame 22 is stably placed on the lower base.

The height adjusting device may include: an upper height adjusting device 42 connected to upper ends of the upper support frame 21 and the upper base to adjust the tilt of the upper support frame 21; and a lower height adjusting device 71 connected to a lower surface of the lower support frame 22 to adjust the height of the lower support frame 22.

In detail, the upper height adjusting device 42 may include an upper gas spring 42. The upper gas spring 42 may include a cylinder 43 having a hollow tube shape and a piston rod 44 inserted into a hollow portion inside the cylinder 43. In detail, the length of the upper gas spring 42 is variable as the piston rod 44 vertically reciprocates with respect to the cylinder 43. That is, gas is injected into the cylinder 43, and the position of the piston rod 44 is varied by pressure applied from the gas to the piston rod 44. A gas opening/closing pin 46 for selectively opening or closing internal gas and an opening/closing guide 45 for operating the gas opening/closing pin 46 may be provided on an upper side of the piston rod 44, and an end of an upper cable 47 may be connected to the opening/closing guide 45. Therefore, when the upper cable 47 is pulled, gas filled in the upper gas spring 42 may be moved, and thus the piston rod 44 may be vertically moved by pressure of the gas. In addition, when force pulling the upper cable 47 is removed, the position of the piston rod 44 is fixed.

In the present disclosure, an upper button portion 35 is connected to the other end of the upper cable 47, and as the upper button portion 35 is manipulated, the upper cable 47 may be pulled for length adjustment. However, any length adjusting configuration using the pressure of a gas or fluid may be applied to the bed of the embodiment of the present disclosure. That is, a hydraulic cylinder or a pneumatic cylinder having a length variable using the pressure of a fluid or air may be used instead of the upper gas spring 42. Therefore, a detailed description of the upper gas spring 42 will be omitted. The following description will be given for the case in which the upper height adjusting device is the upper gas spring.

Both end portions of an upper coupling shaft 23 are coupled to both lateral surfaces of the upper support frame 21. A first fixed portion 24 to which an end portion of the upper gas spring 42 is rotatably hinged is formed on the upper coupling shaft 23. In addition, a second fixed portion 25 to which the other end portion of the upper gas spring 42 is rotatably coupled is formed on an upper end of the upper base.

The first fixed portion 24 may include: a first fixed portion body 24a fixed at a middle position of the upper coupling shaft 23; and a first fixed portion extension 24b extending downward from a side of the first fixed portion body 24a and including a shaft penetrating the end portion of the upper gas spring 42.

In addition, the second fixed portion 25 may include: a second fixed portion body 25a coupled to a center position of the upper end of the upper base; and a second fixed portion extension 25b extending downward from a side of the second fixed portion body 25a and including a shaft penetrating the other end portion of the upper gas spring 42.

In addition, the upper button portion 35 may be attached to a portion of a lateral surface of the upper base for adjusting tension of the upper cable 47 connected to the upper gas spring 42. In detail, the other end of the upper cable 47 is connected to the upper button portion 35, and thus if a user pushes the upper button portion 35, the upper cable 47 is pulled. Thereafter, if the user applies forward force to the upper support frame 21 while pushing the upper button portion 35, the upper support frame 21 may be rotated forward and stood, and if the upper button portion 35 is released from the pushed state, the upper support frame 21 may be fixed in a state in which the upper support frame 21 is stood at a certain angle. In addition, if the user applies downward force to the upper support frame 21 while pushing the upper button portion 35, the upper support frame 21 may be returned to an original position thereof.

The lower height adjusting device may include a plurality of connecting members 51 and 52 and height adjusting units 71 to vary the height of the lower support frame 21 and thus to move the lower mattress 33 relative to the lower base. The plurality of connecting members 51 and 52 may be provided respectively on both sides between the lower support frame 21 and the lower base.

More specifically, the plurality of connecting members 51 and 52 may include first connecting members 52 extending from a lower surface of a rear side of the lower support frame 22 toward a lower surface of a front side of the lower base, and second connecting members 51 extending from a lower surface of a front side of the lower support frame 22 toward a lower surface of a rear side of the lower base. The first connecting members 52 and the second connecting members 51 may cross each other between the lower support frame 22 and the lower base and may approximately form an ‘X’ shape when viewed from a side. To this end, central portions of the first connecting members 52 and the second connecting members 51 may be hinged to each other. In this case, the first and second connecting members 52 and 51 have the same length. If the first and second connecting members 52 and 51 have different lengths, the lower support frame 22 may not be vertically moved in a horizontal posture, but may be vertically reciprocated in a state in which the lower support frame 22 is inclined at an angle.

Ends of the first connecting members 52 are coupled to first coupling portions 26 provided on the lower surface of the front side of the lower support frame 22, and the other ends of the first connecting members 52 are coupled to first movement frames 28 provided on the lower surface of the rear side of the lower base. The first coupling portions 26 and the first movement frames 28 may be provided on both sides of the lower surface of the lower support frame 22 and both sides of the lower surface of the lower base according to the number of first connecting members 52.

The first coupling portions 26 include: first horizontal portions having lower surfaces coupled to the lower surface of the front side of the lower support frame 22 using screws or links; and first vertical portions extending downward from sides of the first horizontal portions and coupled to the ends of the first connecting members 52. The ends of the first connecting members 52 may be rotatably hinged to lateral surfaces of the first vertical portions. That is, the ends of the first connecting members 52 are rotatably coupled to the first vertical portions using hinge pins inserted through the first connecting members 52 and the first vertical portions.

The first movement frames 28 are provided respectively on both sides of the lower surface on the rear side of the lower base. The first movement frames 28 may include: first upper surface portions 28a having upper surfaces coupled to the lower surface of the lower base; and first lateral surface portions 28b extending downward from sides of the first upper surface portions 28a, wherein movement openings 28c extend in the first lateral surface portions 28b in forward and backward directions. First protrusions are formed on the other ends of the first connecting members 52 so as to be inserted into the movement openings 28c and slide in the forward and backward directions along inner surfaces extending in the movement openings 28c, and to this end, the first protrusions may be hinged to the movement openings 28c.

When the first protrusions formed on the other ends of the first connecting members 52 slide in the forward and backward directions, the slope of the first connecting members 52 is varied, and thus the first coupling portions 26 connected to the ends of the first connecting members 52 are vertically moved such that the lower support frame 22 may be vertically reciprocated with respect to the lower base.

Ends of the second connecting members 51 are coupled to second coupling portions 27 provided on the lower surface of the front side of the lower base, and the other ends of the second connecting members 51 are coupled to second movement frames 29 provided on the lower surface of the rear side of the lower support frame 22. The second coupling portions 27 and the second movement frames 29 may be provided on both sides of the lower surface of the base and both sides of the lower surface of the lower support frame 22 according to the number of second connecting members 51.

The second coupling portions 27 include: second horizontal portions having lower surfaces coupled to the lower surface of the front side of the lower base using screws or links; and second vertical portions extending downward from sides of the second horizontal portions and coupled to the ends of the second connecting members 51. The ends of the second connecting members 51 may be rotatably hinged to lateral surfaces of the second vertical portions. That is, the ends of the second connecting members 51 are rotatably coupled to the second vertical portions using hinge pins inserted through the second connecting members 51 and the second vertical portions.

The second movement frames 29 are provided respectively on both sides of the lower surface on the rear side of the lower support frame 22. The second movement frames 29 may include: second upper surface portions 29a having upper surfaces coupled to the lower surface of the lower support frame 22; and second lateral surface portions 29b extending downward from sides of the second upper surface portions 29a, wherein movement openings 29c extend in the second lateral surface portions 29b in forward and backward directions. Second protrusions are formed on the other ends of the second connecting members 51 so as to be inserted into the movement openings 29c and slide in the forward and backward directions along inner surfaces extending in the movement openings 29c. The second protrusions may be inserted into the movement openings 29b.

The height adjusting units 71 may be connected to the second movement frames 29. In detail, the height adjusting units 71 may be spring levers 71. The spring levers 71 may include: movable portions 72 connected to the other ends of the second connecting members 51 and slidable forward and backward along the movement openings while surfaces of the movable portions 72 are brought into contact with or spaced apart from surfaces of the second lateral surface portions; friction portions 73 configured to limit movement of the movable portions 72 when surfaces of the friction portions 73 are brought into contact with the other surfaces of the movable portions 72; fixed portions 74 having a plate shape and fixed at a distance from the friction portions 73; elastically deformable springs 75 placed between the friction portions 73 and the fixed portions 74; lower cables 76 fixed to the other surfaces of the friction portions 73; and lever portions 77 connected to the lower cables 76 and configured to be moved to adjust tension of the lower cables 76.

The surfaces of the movable portions 72 may be fixed to ends of the second protrusions formed on the other ends of the second connecting members 51, and may have areas wider than the areas of the movement openings. In addition, when the second protrusions slide forward or backward in an extension direction of the movement openings, the movable portions 72 may also slide.

The friction portions 73 may reciprocate in directions toward and away from the other surfaces of the movable portions 72 to press or release the other surfaces of the movable portions 72 for limiting movement of the movable portions 72. In detail, a plurality of protrusions may be formed on the surfaces of the friction portions 73, and members such as rubber members capable of increasing friction may be coupled to the plurality of protrusions. When the surfaces 73 of the frictional portions press the other surfaces 72 of the movable portions, movement of the movable portions 72 is limited, and thus sliding of the second protrusions are limited, thereby fixing the second connecting members. Furthermore, in this case, a plurality of recesses corresponding to the plurality of protrusions may be formed in the other surfaces of the movable portions 72.

The fixed portions 74 are fixed to portions of lateral surfaces of the second upper surface portions of the second movement frames 29, and the springs 75 are fixed to surfaces of the fixed portions 74, wherein cable insertion openings may be formed in the fixed portions 74 at positions corresponding to positions to which the springs 75 are fixed so as to receive ends of the lower cables 76.

The springs 75 may be placed between the fixed portions 74 and the friction portions 73 with ends of the springs 75 being fixed to the surfaces of the fixed portions 74 and the other ends of the springs 75 being fixed to the surfaces of the fixed portions 74, and may be compressed or extended according to the positions of the friction portions 73 varying with tension of the lower cables 76. In detail, the springs 75 may be elastically deformed according to the distance between the fixed portions 74 and the friction portions 73.

The ends of the lower cables 76 may be fixed to the other surfaces of the fixed portions 74, and the other ends of the lower cables 76 may be fixed to the lever portions 77 so that the positions of the fixed portions 74 may be varied according to manipulation of the lever portions 77. More specifically, when the lower cables 76 are pulled, the friction portions 73 may be spaced apart from the movable portions 72, and when the lower cables 76 are released, the friction portions 73 may be brought into contact with the movable portions 72 and may limit movement of the movable portions 72.

The lever portions 77 having a lever shape are respectively coupled to both sides of a rear end of the lower surface of the lower support frame 22 with ends of the lever portions 77 protruding backward from the rear end of the lower support frame 22, and the other ends of the lower cables 76 are fixed to the other ends of the lever portions 77, such that tension of the lower cables 76 may be adjusted according to movement of the lever shape of the lever portions 77. In detail, if upward force is applied to the lever portions 77, the lower cables 76 may be pulled, and if the force is removed, the lower cables 76 may be released.

The height adjusting units 72 may be provided on both sides of the lower surface of the lower support frame 22 according to the number of first connecting members 52 and second connecting members 51.

In addition, lever recesses 14 may be formed respectively in both sides of the lower base corresponding to the positions of the lever portions 77 such that a user may easily manipulate the lever portions 77 through the lever recesses 14.

Operations of the upper mattress 31 and the lower mattress 33 will now be described in detail.

When a user presses the upper button portion 35 to adjust the inclination of the upper mattress 31, the upper cable 47 is pulled, and the opening/closing guide 45 operates the opening/closing pin 46, such that gas filled in the upper cylinder 43 may be moved to move the piston rod 44 upward or downward, that is, the length of the gas spring 42 may be varied. That is, the piston rod 44 may move upward, and thus the length of the gas spring 42 may increase. In this case, if the user does not apply any force to the upper mattress 31 while pressing the upper button portion 35, the upper mattress 31 is rotated and erected. In order to lay the upper mattress 31 down, the length of the gas spring 42 may be varied to change the inclination of the upper mattress 31 by pressing an upper surface of the upper mattress 31.

In order to adjust the height of the lower mattress 33, when a user lifts the lower support frame 22 while pulling the lever portions 77 upward through the lever recesses 14 in a state in which the lower mattress 33 and the intermediate mattress 32 are parallel to each other, the lower cables 76 are pulled, and the friction portions 73 are separated from the movable portions 72. In this state, the movable portions 72 are moved forward through the movement openings formed in the second movement frames 29.

When the movable portions 72 are moved forward through the movement openings formed in the second movement frames 29, the first connecting members 52 hinged to the second connecting members 51 are also moved forward through the movement openings formed in the first movement frames 28, and the lower support frame 22 is separated upward from lower base owing to the forward movement of the first connecting members 52 and the second connecting members 51. Accordingly, the lower mattress 33 stably placed on the lower support frame 22 is raised. When the user removes force applied to the lever portions 77 at a proper height, the lower cables 76 are returned to original lengths thereof, and the friction portions 73 press the movable portions 72, thereby limiting movement of the movable portions 72 and stopping the first connecting members 52 and the second connecting members 51.

In addition, when a user pushes the lower support frame 22 downward while pulling the lever portions 77 upward so as to lower the lower support frame 22, the lower cables 76 are pulled, and the friction portions 73 are separated from the movable portions 72. In this state, the movable portions 72 are moved backward through the movement openings formed in the second movement frames 29.

When the movable portions 72 are moved backward through the movement openings formed in the second movement frames 29, the first connecting members 52 hinged to the second connecting members 51 are also moved backward through the movement openings formed in the first movement frames 28, and thus the lower support frame 22 is stably placed on the lower base owing to the backward movement of the first connecting members 52 and the second connecting members 51. Thus, the lower mattress 33 stably placed on the lower support frame 22 is lowered.

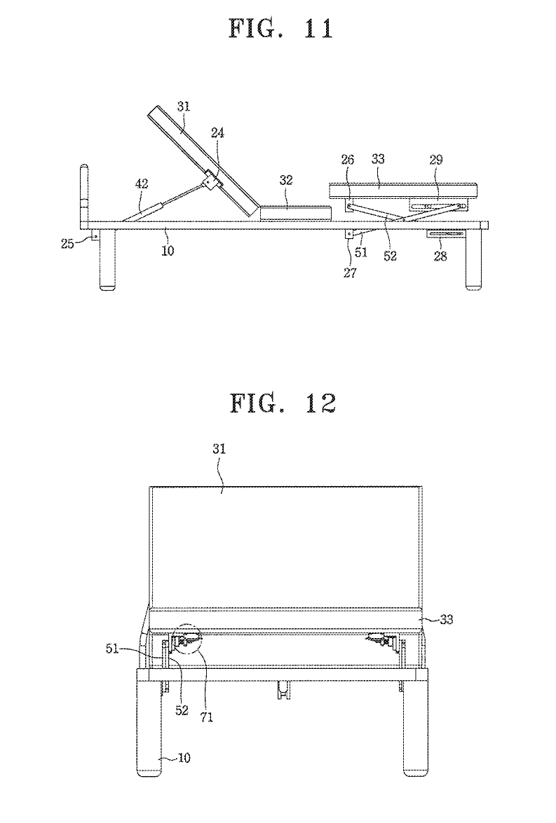

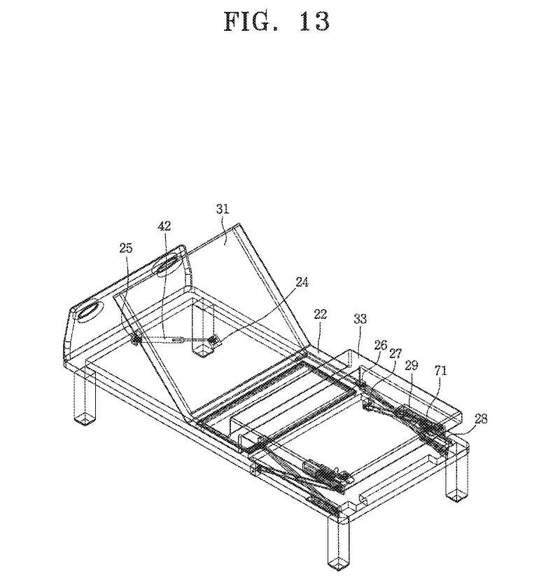

FIG. 11 is a side view illustrating the bed of the embodiment of the present disclosure when used without the support frame 20, FIG. 12 is a rear view illustrating the bed of FIG. 11, and FIG. 13 is a perspective view illustrating the bed of FIG. 11.

Referring to FIGS. 1 to 13, the bed of the embodiment of the present disclosure may operate without the structure of the support frame 20. In this case, when the support frame 20 is removed, the lower surface of the mattress 30 may serve as the support frame 20. That is, the upper support frame 21, the intermediate support frame, and the lower support frame 22 may be removed. In detail, when the upper support frame 21 is removed, the upper gas spring 42 may be coupled to the lower surface of the upper mattress 31. More specifically, the first fixed portion 24 may be fixed to the lower surface of the upper mattress 31, and the second fixed portion 25 may be coupled to the upper base 10. In addition, an end of the upper gas spring 42 may be hinged to the first fixed portion 24, and the other end of the upper gas spring 42 may be hinged to the second fixed portion 25. In this case, a plate-shaped member for securely fixing the first fixed portion 24 may be fixed to the lower surface of the upper mattress 31. However, the embodiment is not limited thereto. That is, the first fixed portion 24 may be directly fixed to the lower surface of the upper mattress 31.

In addition, when the lower support frame 22 is removed, the first connecting members 52 and the second connecting members 51 may be connected to the lower surface of the lower mattress 33. In detail, the first coupling portions 26 may be coupled to a lower surface of a front side of the lower mattress 33, and the second movement frames 29 may be coupled to a lower surface of a rear side of the lower mattress 33. Furthermore, to prevent the first coupling portions 26 and the second movement frames 29 from being exposed to the outside, upwardly-bent recesses may be formed in the lower surface of the lower mattress 33, and the first coupling portions 26 and the second movement frames 29 may be fixed to the lower surface of the lower mattress 33 in a state in which the first coupling portions 26 and the second movement frames 29 are inserted in the upwardly-bent recesses.

That is, even when the support frame 20 is removed from the bed of the embodiment of the present disclosure, a user may adjust the tilt and height of the mattress 30 to obtain desired purposes and effects.

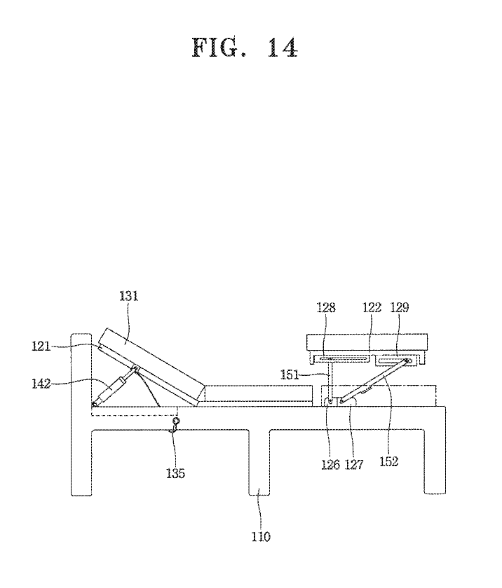

FIG. 14 is a side view illustrating a bed according to a second embodiment of the present disclosure.

The second embodiment of the present disclosure is the same as the first embodiment except for the configuration of a lower height adjusting device. Therefore, in the following description, only characteristic parts of the second embodiment will be described, and descriptions of the same parts as those in the first embodiment will be substituted with previous descriptions.

Referring to FIGS. 1 to 10 and 14, the lower height adjusting device of the bed of the second embodiment of the present disclosure may include a plurality of connecting members 151 and 152 and height adjusting units. More specifically, the plurality of connecting members 151 and 152 may include first connecting members 151 extending from a lower surface of a front side of a lower support frame 122 toward a lower surface of a front side of a lower base, and second connecting members 152 extending from a lower surface of a rear side of the lower support frame 122 toward the lower surface of the front side of the lower base. In this case, the second connecting members 152 may be placed behind the first connecting members 151. The first connecting members 151 and the second connecting members 152 do not cross each other between the lower support frame 122 and the lower base. That is, the first connecting members 151 and the second connecting members 152 do not overlap each other when viewed from a lateral side. That is, the first connecting members 151 and the second connecting members 152 are not coupled to each other.

Ends of the first connecting members 151 are hinged to first coupling portions 126 provided on the lower surface of the front side of the lower base, and the other ends of the first connecting members 151 are hinged to first movement frames 128 provided on the lower surface of the front side of the lower support frame 122.

In addition, ends of the second connecting members 152 are hinged to second coupling portions 127 provided on rear ends of the first coupling portions 126, and the other ends of the second connecting members 152 are hinged to second movement frames 129 provided on the lower surface of the rear side of the lower support frame 122.

The first coupling portions 126 include: first horizontal portions having lower surfaces coupled to an upper surface of the front side of the lower base using screws or links; and first vertical portions extending downward from sides of the first horizontal portions and coupled to the ends of the first connecting members 151. The ends of the first connecting members 151 are rotatably hinged to lateral surfaces of the first vertical portions. That is, the ends of the first connecting members 151 are rotatably coupled to the first vertical portions using hinge pins inserted through the first connecting members 151 and the first vertical portions.

The first movement frames 128 are provided respectively on both sides of the lower surface of the front side of the lower support frame 122. The first movement frames 128 may include: first upper surface portions having upper surfaces coupled to the lower surface of the lower base; and first lateral surface portions extending downward from sides of the first upper surface portions, wherein movement openings extend in the first lateral surface portions in forward and backward directions. First protrusions may be formed on the other ends of the first connecting members 151 so as to be inserted into the movement openings of the first movement frames 128 and slide in the forward and backward directions along inner surfaces extending in the movement openings.

When the first protrusions formed on the other ends of the first connecting members 151 slide in the forward and backward directions, the slope of the first connecting members 151 is varied, and thus the lower support frame 122 may be vertically reciprocated with respect to the lower base.

Ends of the second connecting members 152 are coupled to the second coupling portions 127 provided behind the first coupling portions 126, and the other ends of the second connecting members 152 are coupled to the second movement frames 152 provided on the lower surface of the rear side of the lower support frame 122. The second coupling portions 127 and the second movement frames 129 may be provided on both sides of the lower surface of the base and both sides of the lower surface of the lower support frame 122 according to the number of second connecting members 152.

The second coupling portions 127 include: second horizontal portions having lower surfaces that extend from rear ends of the first horizontal portions of the first coupling portions 126 and are coupled to the upper surface of the lower base using screws or links; and second vertical portions extending downward from sides of the second horizontal portions and coupled to the ends of the second connecting members 152. The ends of the second connecting members 152 are rotatably hinged to lateral surfaces of the second vertical portions. That is, the ends of the second connecting members 152 are rotatably coupled to the second vertical portions using hinge pins inserted through the second connecting members 152 and the second vertical portions.

The second movement frames 129 are provided respectively on both sides of the lower surface of the rear side of the lower support frame 122. The second movement frames 129 may include: second upper surface portions having upper surfaces coupled to the lower surface of the lower support frame 122; and second lateral surface portions extending downward from sides of the second upper surface portions, wherein movement openings extend in the second lateral surface portions in the forward and backward directions. Second protrusions are formed on the other ends of the second connecting members 152 so as to be inserted into the movement openings of the second movement frames 129 and slide in the forward and backward directions along inner surfaces extending in the movement openings. The second protrusions may be inserted into the movement openings.

In addition, the first connecting members 151 and the second connecting members 152 may have different lengths because the first connecting members 151 and the second connecting members 152 do not cross each other. In detail, since the first connecting members 151 have a movable range shorter than that of the second connecting members 152, the first connecting members 151 may be shorter than the second connecting members 152.

The height adjusting units connected to the second movement frames 129 have the same configuration and operation as those described in the first embodiment, and thus descriptions thereof will be omitted.

That is, in the bed of the first embodiment of the present disclosure, the first connecting members 52 and the second connecting members 51 crossing each other are used to vertically reciprocate the lower support frame 22. However, in the bed of the second embodiment of the present disclosure, the first connecting members 151 and the second connecting members 152 not crossing each other may be moved to vertically reciprocate the lower support frame 122.

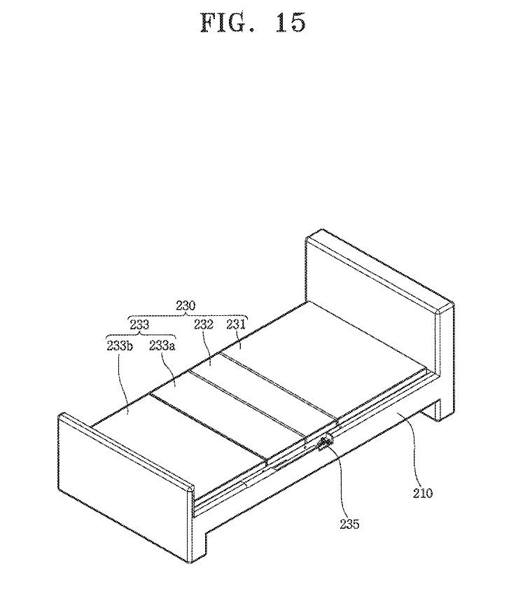

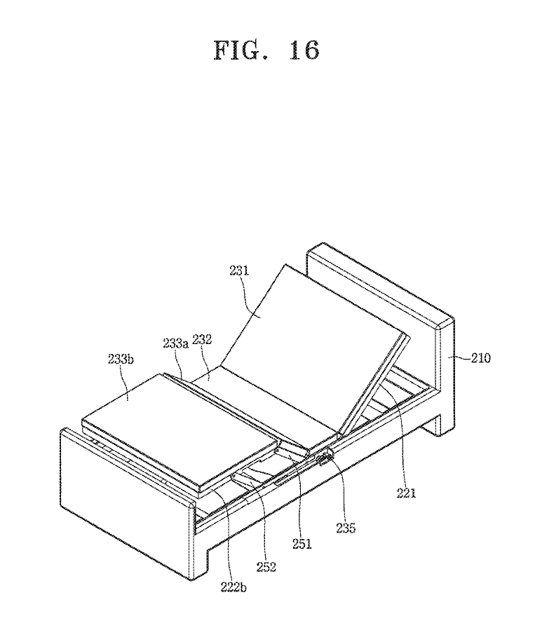

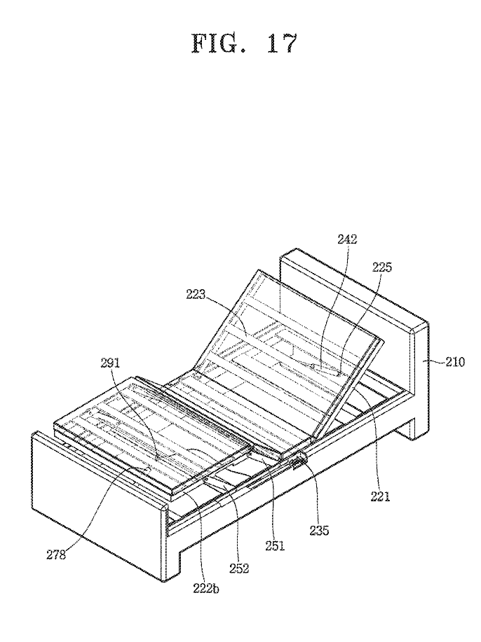

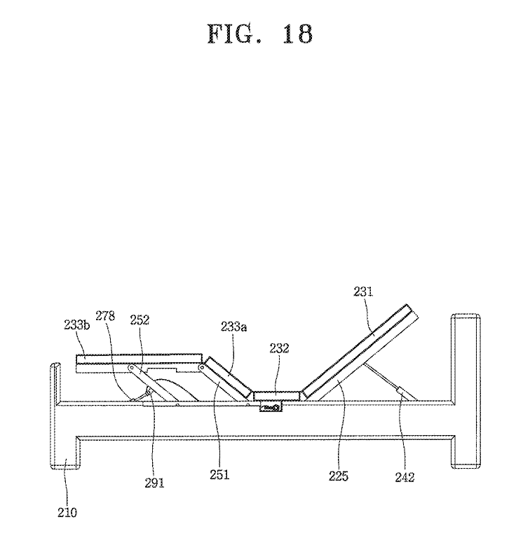

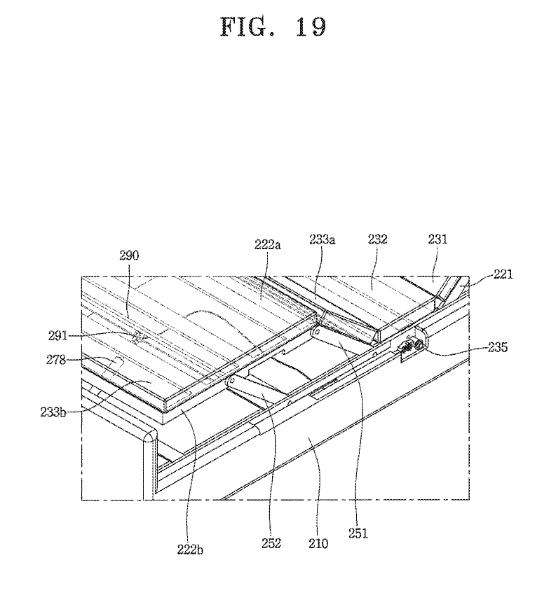

FIG. 15 is a perspective view illustrating a bed according to a third embodiment of the present disclosure, and FIG. 16 is a perspective view illustrating a height adjusting operation of the bed of the third embodiment of the present disclosure. FIG. 17 is a perspective view illustrating the bed of FIG. 16 with a mattress of the bed being transparently illustrated, FIG. 18 is a side view illustrating the bed FIG. 16, and FIG. 19 is an enlarged view illustrating a configuration of a lower support frame of the bed of FIG. 16.

The third embodiment of the present disclosure is the same as the first embodiment except for the configurations and operations of a lower support frame 222, a lower mattress 233 and a lower height adjusting device. Therefore, in the following description, only characteristic parts of the third embodiment will be described, and descriptions of the same parts as those in the first embodiment will be substituted with previous descriptions and will not be repeated here.

Referring to FIGS. 15 to 19, the lower support frame 222 of the bed of the third embodiment of the present disclosure may include: a first lower support frame 222a placed on an intermediate support frame; and a second lower support frame 222b rotatably hinged to both sides of a rear end of the first lower support frame 222a.

In addition, the lower mattress 233 may include: a first lower mattress 233a stably placed on the first lower support frame 222a; and a second lower mattress 233b bendable from the first lower mattress 233a and separate from the first lower mattress 233a, the second lower mattress 233b being stably placed on the second lower support frame 222b.

The lower height adjusting device may include a lower gas spring 278, a lower coupling shaft 290, a third fixed portion 291, a fourth fixed portion, a plurality of connecting members 251 and 252, and a lower button portion 235.

The lower gas spring 278 has the same configuration and operation as the upper gas spring 42 of the bed of the first embodiment, and thus a repeated description thereof will be omitted.

Both end portions of the lower coupling shaft 290 are coupled to centers of both lateral surfaces of the second lower support frame 222b. The third fixed portion 291 to which an end portion of the lower gas spring 278 may be rotatably hinged is formed on a center portion of the lower coupling shaft 290. In addition, the fourth fixed portion to which the other end portion of the lower gas spring 278 may be rotatably coupled is formed on a lower end of a lower base.

The third gas spring coupling portion 291 may include a third fixed portion body fixed to a center portion of the lower coupling shaft 290, and a third fixed portion extension extending downward from a side of the third fixed portion body and including a shaft inserted through the end portion of the lower gas spring 278.

In addition, the fourth gas spring coupling portion may include a fourth fixed portion body fixed to a center portion of a rear end of the lower base, and a fourth fixed portion extension extending downward from a side of the fourth fixed portion body and including a shaft inserted through the other end portion of the lower gas spring 278.

The plurality of connecting members 251 and 252 may be coupled to lateral surfaces of the lower support frame 222 and inner lateral surfaces of the lower base. In detail, the plurality of connecting members 251 and 252 may include: first connecting members 251 having ends hinged to leading ends of lateral surfaces of the lower base and the other ends hinged to rear ends of lateral surfaces of the first lower support frame 222a, the first connecting members 251 being parallel to the lateral surfaces of the first lower support frame 222a; and second connecting members 252 having ends hinged to center portions of the lateral surfaces of the lower base and the other ends hinged to lateral surfaces of the second lower support frame 222b. The first connecting members 251 and the second connecting members 252 may be coupled to both the lateral surfaces of the lower base and the lateral surfaces of the lower support frame 222. In addition, the first connecting members 251 and the second connecting members 252 may have the same length, and the first connecting members 251 and the second connecting members 252 may be spaced apart from each other in parallel to each other such that the first connecting members 251 and the second connecting members 252 may be equally moved at the same angle.

The lower button portion 235 is placed on a portion of a lateral surface of a base 210 and is connected to a lower cable of the lower gas spring 278 to adjust tension of the lower cable. The lower button portion 235 has the same structure and operation as those of the upper button portion 35 connected to the upper gas spring 42 of the first embodiment, and thus a repeated description thereof will be omitted.

When a user pushes the lower button portion 235, the length of the lower gas spring 278 is increased by the lower cable. As the lower gas spring 278 is extended, the third fixed portion 291 is pushed upward, and thus the first lower support frame 222a and the second lower support frame 222b are lifted. In this case, since the first and second connecting members 251 and 252 have the same length, the first connecting members 251 and the second connecting members 252 are lifted at the same angle. Accordingly, the first lower support frame 222a connected to the first connecting members 251 may be lifted at the same angle as the angle of the first connecting members 251, and the second lower support frame 222b connected to the rear end of the first lower support frame 222a may be lifted in parallel to the ground by the end portion of the lower gas spring 291 and the second connecting members 252. After the second lower support frame 222b is lifted by a desired amount, if the lower button portion 235 is released from the pushed state, the first lower support frame 222a and the second lower support frame 222b are stopped and fixed. In this case, a user may place his/her thighs on the first lower mattress 233a stably placed on the first lower support frame 222a and his/her calves on the second lower mattress 233b stably placed on the second lower support frame 222b.

Furthermore, in this state, if the user pushes downward the first and second lower mattresses 233a and 233b with his/her lower body while pushing the lower button portion 235, the first lower support frame 222a and the second lower support frame 222b are moved downward, and thus the first and second lower mattresses 233a and 233b are also moved downward to original positions thereof.

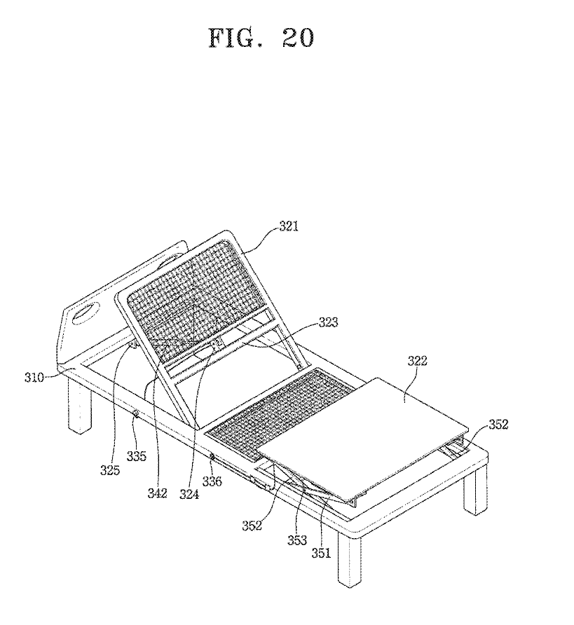

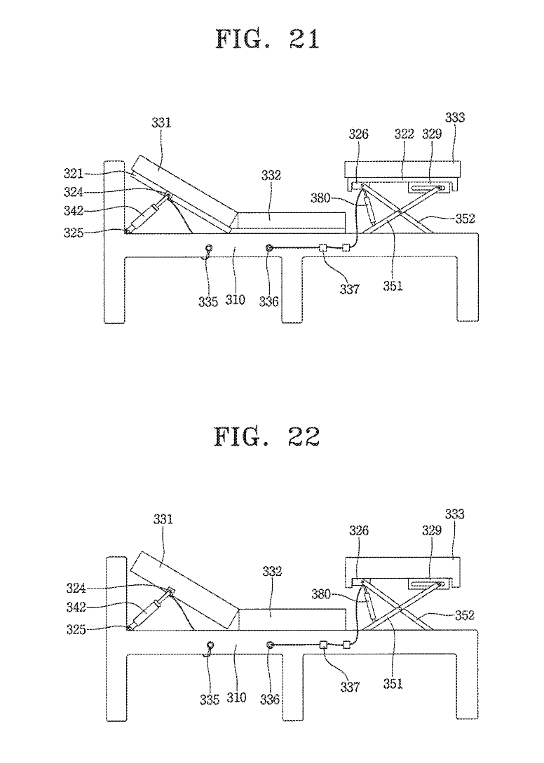

FIG. 20 is a perspective view illustrating a bed according to a fourth embodiment of the present disclosure, and FIG. 21 is a side view illustrating the bed of the fourth embodiment of the present disclosure.

The fourth embodiment of the present disclosure is the same as the first embodiment except for the configuration of a lower height adjusting device. Therefore, in the following description, only characteristic parts of the fourth embodiment will be described, and descriptions of the same parts as those in the first embodiment will be substituted with previous descriptions and will not be repeated here.

Referring to FIGS. 15 to 21, the lower height adjusting device of the bed of the fourth embodiment of the present disclosure may include a plurality of connecting members 351 and 352 and a height adjusting unit 380, and the height adjusting unit 380 may include at least one lower gas spring 380.

The configuration of the at least one lower gas spring 380 is the same as the configuration of the upper gas spring 42 of the first embodiment except for coupling structures of both ends of the lower gas spring 380 which are described later.

The plurality of connecting members 351 and 352 are for moving a lower support frame 322 relative to a lower base and may be provided on both sides between the lower support frame 322 and the lower base.

More specifically, the plurality of connecting members 351 and 352 may include: first connecting members 352 extending from a lower surface of a front side of the lower support frame 322 toward a lower surface of a rear side of the lower base; and second connecting members 351 extending from a lower surface of a rear side of the lower support frame 322 toward a lower surface of a front side of the lower base. The first connecting members 352 and the second connecting members 351 may cross each other between the lower support frame 322 and the lower base and may approximately form an ‘X’ shape when viewed from a side. To this end, central portions of the first connecting members 352 and the second connecting members 351 may be hinged to each other. In this case, the first and second connecting members 352 and 351 have the same length. If the first and second connecting members 352 and 351 have different lengths, the lower support frame 322 may not be vertically moved in a horizontal posture, but may be vertically reciprocated in a state in which the lower support frame 322 is inclined at an angle.

In addition, both end portions of a lower coupling shaft 353 are coupled to inner lateral surfaces of the second connecting members 351 formed on both sides of a lower mattress 333. An end portion of the lower gas spring 380 may be rotatably hinged to the lower coupling shaft 353. This will be described later.

Ends of the first connecting members 352 are coupled to first coupling portions 326 provided on the lower surface of the front side of the lower support frame 322, and the other ends of the first connecting members 352 are coupled to first movement frames provided on the lower surface of the rear side of the lower base. The first coupling portions 326 and the first movement frames may be provided on both sides of the lower surface of the lower support frame 322 and both sides of the lower surface of the lower base according to the number of first connecting members 352.

The first coupling portions 326 include: first horizontal portions having lower surfaces coupled to the lower surface of the front side of the lower support frame 322 using screws or links; and first vertical portions extending downward from sides of the first horizontal portions and coupled to the ends of the first connecting members 352, wherein the ends of the first connecting members 352 may be rotatably hinged to lateral surfaces of the first vertical portions. That is, the ends of the first connecting members 352 may be rotatably coupled to the first vertical portions using hinge pins inserted through the first connecting members 352 and the first vertical portions.

The first movement frames have the same structure as that of the first movement frames 28 of the first embodiment and are provided respectively on both sides of the lower surface on the rear side of the lower base. The first movement frames may include: first upper surface portions having upper surfaces coupled to the lower surface of the lower base; and first lateral surface portions extending downward from sides of the first upper surface portions, wherein movement openings extend in the first lateral surface portions in forward and backward directions. First protrusions are formed on the other ends of the first connecting members 351 so as to be inserted into the movement openings of the first movement frames and slide in the forward and backward directions along inner surfaces extending in the movement openings. The first protrusions may be inserted into the movement openings of the first movement frames.

When the first protrusions formed on the other ends of the first connecting members 352 slide in the forward and backward directions, the slope of the first connecting members 352 are varied, and thus the first coupling portions 326 connected to the ends of the first connecting members 352 are vertically moved such that the lower support frame 322 may be vertically reciprocated with respect to the lower base.

Ends of the second connecting members 351 are coupled to second coupling portions provided on the lower surface of the front side of the lower base, and the other ends of the second connecting members 351 are coupled to second movement frames 329 provided on the lower surface of the rear side of the lower support frame 322. The second coupling portions and the second movement frames 329 may be provided on both sides of the lower surface of the base and both sides of the lower surface of the lower support frame 322 according to the number of second connecting members 351.

The second coupling portions have the same configuration as that of the second coupling portions 27 of the first embodiment. That is, the second coupling portions include: second horizontal portions having lower surfaces coupled to the lower surface of the front side of the lower base using screws or links; and second vertical portions extending downward from sides of the second horizontal portions and coupled to the ends of the second connecting members 351. The ends of the second connecting members 351 are rotatably hinged to lateral surfaces of the second vertical portions. That is, the ends of the second connecting members 351 are rotatably coupled to the second vertical portions using hinge pins inserted through the second connecting members 351 and the second vertical portions.

The second movement frames 329 are provided respectively on both sides of the lower surface on the rear side of the lower support frame 322. The second movement frames 329 may include: second upper surface portions having upper surfaces coupled to the lower surface of the lower support frame 322; and second lateral surface portions extending downward from sides of the second upper surface portions, wherein movement openings extend in the second lateral surface portions in the forward and backward directions. Second protrusions are formed on the other ends of the second connecting members 351 so as to be inserted into the movement openings of the second movement frames 329 and slide in the forward and backward directions along inner surfaces extending in the movement openings. The second protrusions may be inserted into the movement openings formed in the second movement frames 329.

In addition, an end of the at least one lower gas spring 380 may be rotatably hinged to the lower coupling shaft 353, and the other end of the at least one lower gas spring 380 may be rotatably hinged to a front lower surface of the lower support frame 322.

In addition, a lower button portion 336 may be connected to an end of a lower cable of the lower gas spring 380. When a user presses the lower button portion 336, tension of the lower cable may be adjusted to vary the length of the lower gas spring 380.

For example, the lower cable may be long such that the lower cable may be hooked on button portion fixing tabs 337 provided on a lateral surface of the lower base. The button portion fixing tabs 337 may have a hook shape bent upward from the lateral surface of the lower base, and the lower cable may be placed on bent portions of the button portion fixing tabs 337 to place the lower button portion 336 on the lateral surface of the lower base.

When a user pushes the lower button portion 336, the lower cable is pulled, and thus the length of the lower gas spring 380 may be increased. Then, as the first connecting members 352 and the second connecting members 351 slide in the movement openings formed in the first movement frames and the second movement frames 329, the lower support frame 322 is lifted from the lower base. That is, the lower mattress 333 placed on an upper portion of the lower support frame 322 is also lifted. In addition, if the user releases the lower button portion 336 at a certain height, the lower cable is released, and thus the length of the lower gas spring 380 is not varied but is fixed.

In this state, if the user pushes the lower mattress 333 downward while pushing the lower button portion 336, the length of the lower gas cylinder 380 is decreased, and the lower support frame 322 is moved downward, thereby returning the lower mattress 322 to an original position thereof.

FIG. 22 is a side view illustrating the bed of the fourth embodiment of the present disclosure when used without a support frame.

Referring to FIGS. 15 to 22, the bed of the fourth embodiment of the present disclosure may operate without the support frame 320. In this case, when the support frame 320 is removed, a lower surface of a mattress 330 may serve as the support frame 320. That is, an upper support frame 321, an intermediate support frame, and the lower support frame 322 may be removed. In detail, when the upper support frame 321 is removed, an upper gas spring 342 may be coupled to a lower surface of an upper mattress 331. More specifically, a first fixed portion 324 may be fixed to the lower surface of the upper mattress 331, and a second fixed portion 325 may be coupled to an upper base 310. In addition, an end of the upper gas spring 342 may be hinged to the first fixed portion 324, and the other end of the upper gas spring 342 may be hinged to the second fixed portion 325. In this case, a plate-shaped member for securely fixing the first fixed portion 324 may be fixed to the lower surface of the upper mattress 331. However, the fourth embodiment is not limited thereto. That is, the first fixed portion 324 may be directly fixed to the lower surface of the upper mattress 331.

In addition, when the lower support frame 322 is removed, the first connecting members 352 and the second connecting members 351 may be connected to a lower surface of the lower mattress 333. In detail, the first coupling portions 326 may be coupled to a lower surface of a front side of the lower mattress 333, and the second movement frames 329 may be coupled to a lower surface of a rear side of the lower mattress 333. Furthermore, to prevent the first coupling portions 326 and the second movement frames 329 from being exposed to the outside, upwardly-bent recesses may be formed in the lower surface of the lower mattress 333, and the first coupling portions 326 and the second movement frames 329 may be fixed to the lower surface of the lower mattress 333 in a state in which the first coupling portions 26 and the second movement frames 29 are inserted in the upwardly-bent recesses.

In addition, the end of the at least one lower gas spring 380 may be rotatably hinged to the lower coupling shaft 353, and the other end of the at least one lower gas spring 380 may be rotatably hinged to a front lower surface of the lower mattress 333.

That is, even when the support frame is removed from the bed of the embodiment of the present disclosure, a user may adjust the tilt and height of the mattress to obtain desired purposes and effects.

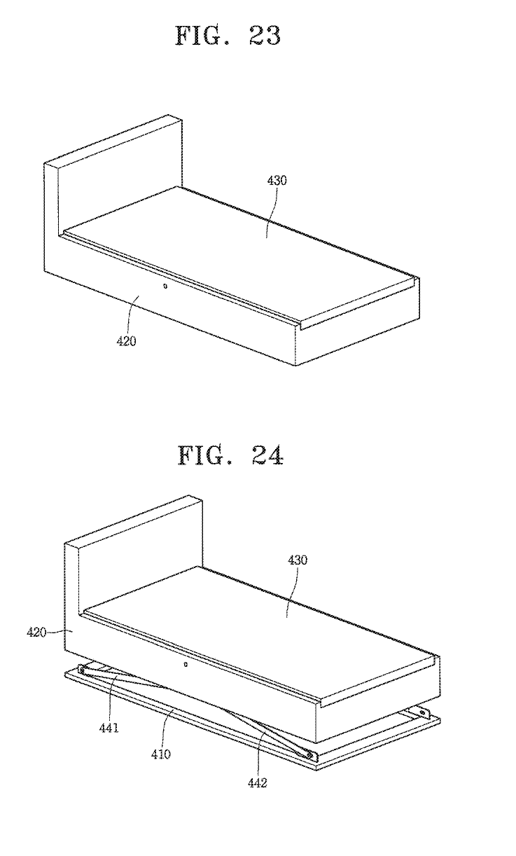

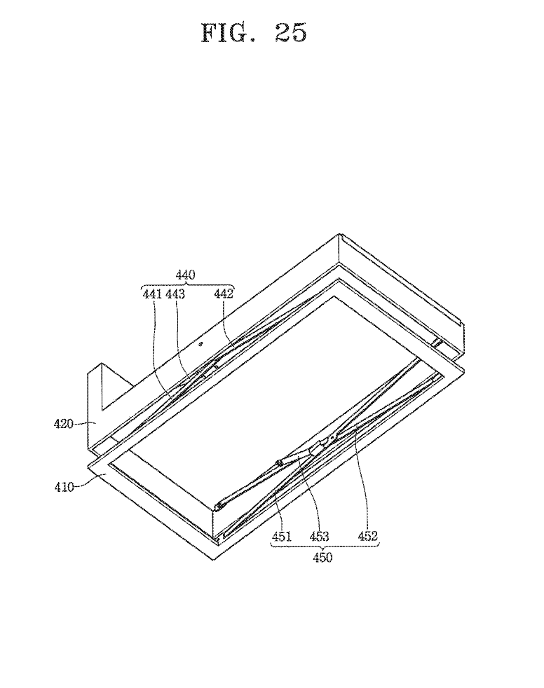

FIG. 23 is a perspective view illustrating a height-adjustable bed according to a fifth embodiment of the present disclosure, FIG. 24 is a perspective view illustrating a height adjusting operation of the height-adjustable bed of the fifth embodiment of the present disclosure, and FIG. 25 is a bottom perspective view illustrating the height-adjustable bed of the fifth embodiment of the present disclosure.

Referring to FIGS. 23 to 25, the height-adjustable bed of the fifth embodiment of the present disclosure may include: a base 410, a support frame 420 placed on an upper portion of the base 410; a mattress 430 placed on an upper portion of the support frame 420; and a height adjusting device placed between the base 410 and the support frame 420 to adjust the height of the mattress 430 with respect to the base 410.

The height adjusting device may include a first height adjusting device 440 and a second height adjusting device 450 that are provided respectively on both sides of the base 410 and the support frame 420.

In detail, the first height adjusting device 440 may be placed on sides of the base 410 and the support frame 420 and connected to the base 410 and the support frame 420. In more detail, the first height adjusting device 440 may include: a first connecting frame 441 having a straight shape and configured to connect a front end portion of a side of the base 410 to a rear end portion of a side of the support frame 420; and a second connecting frame 442 having a straight shape and configured to connect a rear end portion of the side of the base 410 to a front end portion of the side of the support frame 420. In addition, the first connecting frame 441 and the second connecting frame 442 may be hinged to each other in an X-shape.

In addition, a first gas spring 443 may be placed between the first connecting frame 441 and the second connecting frame 442. In detail, a rear end portion of the first gas spring 443 is connected to a center portion of the first connecting frame 441, and a front end portion of the first gas spring 443 is connected to a portion of the second connecting frame 442 ahead of the center portion of the first connecting frame 441, such that the first connecting frame 441 and the second connecting frame 442 may be operated according to extension of the first gas spring 443.

The second height adjusting device 450 may be placed on the other sides of the base 410 and the support frame 420 and connected to the base 410 and the support frame 420. In more detail, the second height adjusting device 450 may include: a third connecting frame 451 having a straight shape and configured to connect a front end portion of the other side of the base 410 to a rear end portion of the other side of the support frame 420; and a fourth connecting frame 452 having a straight shape and configured to connect a rear end portion of the other side of the base 410 to a front end portion of the other side of the support frame 420. In addition, the third connecting frame 451 and the fourth connecting frame 452 may be hinged to each other in an X-shape. In this case, the third connecting frame 451 and the fourth connecting frame 452 may face the first connecting frame 441 and the second connecting frame 442.

In addition, a second gas spring 453 may be placed between the third connecting frame 451 and the fourth connecting frame 452. In detail, a rear end portion of the second gas spring 453 is connected to a center portion of the third connecting frame 451, and a front end portion of the second gas spring 453 is connected to a portion of the fourth connecting frame 452 ahead of the center portion of the third connecting frame 451, such that the third connecting frame 451 and the fourth connecting frame 452 may be operated according to extension of the second gas spring 453.

In addition, the first gas spring 443 and the second gas spring 453 may be extended by the same amount, and the height of the mattress 430 stably placed on the support frame 420 may be adjusted with respect to the base 410 by hinge motions of the first, second, third, and fourth connecting frames 441, 442, 451, and 452 according to the extension of the first gas spring 443 and the second gas spring 453.

### INDUSTRIAL APPLICABILITY

The present disclosure relates to a height-adjustable bed.

1. A height-adjustable bed comprising:
a base;
a support frame placed on an upper surface of the base;
a mattress stably placed on an upper surface of the support frame; and
a height adjusting device connected to the support frame and the base to adjust a height and tilt of the support frame,
wherein the height adjusting device comprises at least one gas spring or spring lever, and the height of the support frame is manually adjusted.

2. The height-adjustable bed of claim 1, wherein the mattress comprises an upper mattress and a lower mattress,
the support frame comprises an upper support frame on which the upper mattress is stably placed and a lower support frame on which the lower mattress is stably placed,
the base comprises an upper base on which the upper support frame is stably placed and a lower base on which the lower support frame is stably placed, and
the height adjusting device comprises an upper height adjusting device comprising an upper gas spring configured to adjust a tilt of the upper support frame, and a lower height adjusting device comprising a lower gas spring or spring lever configured to adjust a height of the lower support frame.

3. The height-adjustable bed of claim 2, wherein both end portions of an upper coupling shaft are coupled to both lateral surfaces of the upper support frame,
an end of the upper gas spring is hinged to the upper coupling shaft, and the other end of the upper gas spring is hinged to a front end of the base, and
the tilt of the upper support frame is varied according to operation of the upper gas spring.

4. The height-adjustable bed of claim 3, wherein the upper coupling shaft comprises a first fixed portion rotatably coupled to the end of the upper gas spring, and
the front end of the base comprises a second fixed portion to which the other end of the upper gas spring is rotatably coupled.

5. The height-adjustable bed of claim 4, further comprising an upper button portion placed on a lateral surface of the base and coupled to a cable of the upper gas spring to adjust tension of the cable when a user applies external force.

6. The height-adjustable bed of claim 2, wherein the lower height adjusting device comprises:
a plurality of spring levers respectively placed on both sides of the lower support frame to adjust a height between the lower support frame and the lower base; and
a plurality of connecting members connecting both sides of the lower support frame and the lower base to each other, at least one of the plurality of connecting members being coupled to the plurality of spring levers.

7. The height-adjustable bed of claim 6, wherein the plurality of connecting members comprise:
first connecting members connecting both the sides of the lower support frame and the lower base to each other; and
second connecting members connected to the plurality of spring levers and connecting both the sides of the lower support frame and the lower base.

8. The height-adjustable bed of claim 7, further comprising:
first coupling portions provided on a lower surface of a front side of the lower support frame, ends of the first connecting members being hinged to the first coupling portions;
first movement frames provided on a lower surface of a rear side of the lower base and comprising first movement openings to which the other ends of the first connecting members are coupled in a forward and backward slidable manner;
second coupling portions provided on a lower surface of a front side of the lower base, ends of the second connecting members being hinged to the second coupling portions; and
second movement frames provided on a lower surface of a rear side of the lower support frame and comprising second movement openings to which the other ends of the second connecting members are coupled in a forward and backward slidable manner,
wherein the first connecting members and the second connecting members are connected to each other using rotation shafts.

9. The height-adjustable bed of claim 8, further comprising:
first coupling portions provided on an upper surface of a front side of the lower base, ends of the first connecting members being hinged to the first coupling portions;
first movement frames provided on a lower surface of a front side of the lower support frame and comprising first movement openings to which the other ends of the first connecting members are coupled in a forward and backward slidable manner;
second coupling portions provided on rear ends of the first coupling portions, ends of the second connecting members being hinged to the second coupling portions; and
second movement frames provided on a lower surface of a rear side of the lower support frame and comprising second movement openings to which the other ends of the second connecting members are coupled in a forward and backward slidable manner,
wherein the first connecting members and the second connecting members are not coupled to each other.

10. The height-adjustable bed of claim 8, wherein protrusions are formed on the other ends of the second connecting members and inserted through the second movement openings to allow the second connecting members to slide forward and backward,
the spring levers are connected to ends of the protrusions and are brought into contact with or spaced apart from the second movement frames, and
when the spring levers are in contact with the second movement frames, forward and backward sliding of the protrusions is limitable.

11. The height-adjustable bed of claim 10, wherein the spring levers comprise:
movable portions connected to the ends of the protrusions inserted through the second movement openings and having surfaces capable of being brought into contact with or spaced apart from the second movement frames, the movable portions being movable as the protrusions slide;
friction portions having surfaces configured to press the other surfaces of the movable portions to limit movement of the movable portions by friction;
fixed portions spaced apart from the friction portions by a distance and fixed to the second movement frames, the fixed portions comprising cable insertion openings;
elastically deformable springs placed between the friction portions and the fixed portions;
cables inserted in the cable insertion openings and having ends fixed to the other surfaces of the friction portions; and
lever portions connected to the other ends of the cables and adjusting tension of the cables according to external force applied by a user,
wherein, when a user applies external force to the lever portions, the cables are pulled to compress the springs, and the friction portions release the movable portions to allow the protrusions to slide forward or backward.

12. The height-adjustable bed of claim 11, wherein a plurality of protrusions are formed on the surfaces of the friction portions,
a plurality of recesses corresponding to shapes of the plurality of protrusions are formed in the other surfaces of the movable portions, and
when the surfaces of the fiction portions press the other surfaces of the movable portions, the plurality of protrusions are inserted into the plurality of recesses.

13. The height-adjustable bed of claim 2, wherein the lower height adjusting device comprises:
a plurality of connecting members provided on both sides of the lower support frame to connect the lower support frame to the lower base; and
at least one lower gas spring placed between the lower support frame and the lower base to adjust the height of the lower support frame.

14. The height-adjustable bed of claim 13, further comprising a lower button portion placed on a lateral surface of the base and coupled to a cable of the lower gas spring such that tension of the cable is adjusted when a user applies external force to the lower button portion.

15. The height-adjustable bed of claim 13, wherein both end portions of a lower coupling shaft are coupled to both lateral surfaces of the lower support frame,
an end of the lower gas spring is hinged to the lower coupling shaft, and the other end of the lower gas spring is hinged to a rear end of the base, and
the height of the lower support frame is varied according to operation of the lower gas spring.

16. The height-adjustable bed of claim 15, wherein the lower mattress comprises a first lower mattress and a second lower mattress placed on a rear end of the first lower mattress,
the lower support frame comprises a first lower support frame on which the first lower mattress is stably placed and a second lower support frame on which the second lower mattress is stably placed, the second lower support frame being rotatably hinged to both sides of a rear end of the first lower support frame, and
both the end portions of the lower coupling shaft are coupled to both lateral surfaces of the second lower support frame, and when the lower gas spring is extended, a height of the second lower support frame is adjusted in a state in which the second lower support frame is parallel to ground.

17. The height-adjustable bed of claim 16, wherein the plurality of connecting members comprise:
a first connecting member having an end hinged to a lateral surface of the base and the other end hinged to a lateral surface of the first lower support frame; and
a second connecting member having an end hinged to the lateral surface of the base and the other end hinged to a lateral surface of the second lower support frame,
wherein the first and second connecting members are movable in parallel to each other.

18. The height-adjustable bed of claim 13, wherein the plurality of connecting members comprise:
first connecting members connecting the lower support frame and the lower base to each other; and
second connecting members connected to the first connecting members through rotation shafts and connecting the lower support frame and the lower base to each other,
wherein the lower coupling shaft to which the lower gas spring is connected is placed between the second connecting members provided on both sides of the lower support frame.

19. The height-adjustable bed of claim 18, further comprising:
first coupling portions provided on a lower surface of a front side of the lower support frame, ends of the first connecting members being hinged to the first coupling portions;
first movement frames provided on a lower surface of a rear side of the lower base and comprising first movement openings to which the other ends of the first connecting members are coupled in a forward and backward slidable manner;
second coupling portions provided on a lower surface of a front side of the lower base, ends of the second connecting members being hinged to the second coupling portions; and
second movement frames provided on a lower surface of a rear side of the lower support frame and comprising second movement openings to which the other ends of the second connecting members are coupled in a forward and backward slidable manner.

20. A height-adjustable bed comprising:
a base;
a mattress stably placed on an upper surface of the base; and
a height adjusting device connected to the base and the mattress to adjust a height and tilt of the mattress,
wherein the height adjusting device comprises at least one gas spring or spring lever, and the height and tilt of the mattress are manually adjusted.

21. The height-adjustable bed of claim 20, wherein the mattress comprises an upper mattress and a lower mattress,
the base comprises an upper base on which the upper mattress is stably placed and a lower base on which the lower mattress is stably placed, and
the height adjusting device comprises an upper height adjusting device comprising an upper gas spring configured to adjust a tilt of the upper mattress, and a lower height adjusting device comprising a lower gas spring or spring lever configured to adjust a height of the lower mattress.

22. The height-adjustable bed of claim 1, wherein the height adjusting device further comprises:
a first height adjusting device connected to sides of the base and the support frame to adjust a height and tilt of the mattress; and
a second height adjusting device connected to the other sides of the base and the support frame to adjust the height and tilt of the mattress,
wherein the first and second height adjusting devices are adjusted in height by gas springs.

23. The height-adjustable bed of claim 22, wherein the first height adjusting device comprises:
a first connecting frame connecting a front end portion of a side of the base and a rear end portion of a side of the support frame to each other;
a second connecting frame connecting a rear end portion of the side of the base and a front end portion of the side of the support frame to each other; and
a first gas spring placed between the first connecting frame and the second connecting frame,
wherein the first and second connecting frames are connected to each other in an X-shape.

24. The height-adjustable bed of claim 23, wherein the second height adjusting device comprises:
a third connecting frame connecting a front end portion of the other side of the base and a rear end portion of the other side of the support frame to each other;
a fourth connecting frame connecting a rear end portion of the other side of the base and a front end portion of the other side of the support frame to each other; and
a second gas spring placed between the third connecting frame and the fourth connecting frame,
wherein the third and fourth connecting frames are connected to each other in an X-shape.

25. The height-adjustable bed of claim 24, wherein lengths of the first and second gas springs are extended by the same amount.
